(19) United States
(12) Patent Application Publication
(10) Pub. No.: US 2018/0215406 A1
(43) Pub. Date: Aug. 2, 2018

(54) VEHICLE STEERING DEVICE

(71) Applicant: HONDA MOTOR CO., LTD., Tokyo (JP)

(72) Inventor: Takamitsu Tajima, Wako-shi (JP)

(21) Appl. No.: 15/877,410

(22) Filed: Jan. 23, 2018

(30) Foreign Application Priority Data
Jan. 27, 2017 (JP) 2017-012770

(51) Int. Cl. B62D 1/04; B62D 5/00

(52) U.S. Cl. CPC B62D 1/046; B62D 1/06; B62D 1/043; B62D 5/001

(57) ABSTRACT

In steering members of a steering device, a shift-up switch and a shift-down switch for upshifting or downshifting with respect to a transmission are provided to respective inner sides in a vehicle width direction of truncated square pyramidal parts at upper end portions of grip parts. On-off switches for switching between a plurality of vehicle behavior controls are provided to respective front sides of the truncated square pyramidal parts. A characteristic amount addition switch and a characteristic amount subtraction switch respectively for increase and decrease a characteristic amount of a vehicle behavior control are disposed respectively at bottoms of concave portions formed on rear sides or outer sides in the vehicle width direction on the truncated square pyramidal parts.

### CROSS-REFERENCE TO RELATED APPLICATION

This application is based upon and claims the benefit of priority from Japanese Patent Application No. 2017-012770 filed on Jan. 27, 2017, the contents of which are incorporated herein by reference.

### BACKGROUND OF THE INVENTION

### Field of the Invention

The present invention relates to a vehicle steering device including an operation element which is used to steer a vehicle by being moved in a front-back direction of the vehicle with driver's left and right hands.

### Description of the Related Art

For example, Japanese Laid-Open Patent Publication No. 2005-225384 discloses a vehicle steering device including left and right sticks in FIG. 4 of the publication. In this steering device, the sticks extend from a hub portion connected to a steering shaft, respectively to the lower left and lower right in a spoke-like shape so as to approach a driver, and further extend from ends of the spoke-like shape to the front side of the vehicle (paragraphs [0022], [0023] in the above publication).

In this case, by moving each stick to the left or right, the steered wheels can be turned in the stick moving direction, so that the vehicle can be steered. In addition, an end of each stick is provided with a button switch for operating a blinker or shifting a transmission (paragraph [0023] in the above publication).

### SUMMARY OF THE INVENTION

However, the vehicle steering device according to Japanese Laid-Open Patent Publication No. 2005-225384 does not disclose that the end of each stick is provided with a plurality of button switches.

The present invention has been made by further improving the vehicle steering device according to Japanese Laid-Open Patent Publication No. 2005-225384, and it is an object of the present invention to provide a vehicle steering device in which an end of each operation element to be operated by a driver is provided with a plurality of switches and the operability of each switch is enhanced.

According to an aspect of the present invention, a vehicle steering device includes operation elements which are provided on left and right sides in front of a driver's seat and are moved in a front-back direction of a vehicle by left and right hands of a driver, to thereby steer the vehicle, wherein the operation elements respectively include grip members to be held by the left and right hands of the driver, and an upper end portion of each of the grip members is provided with a plurality of switches.

In this case, an inner side in a vehicle width direction on the upper end portion of each of the grip members is provided with a first switch to which a function of upshifting or downshifting with respect to a transmission of the vehicle is allocated. In addition, a front side of the upper end portion of each of the grip members is provided with a second switch to which a function of switching between a plurality of vehicle behavior controls with respect to the vehicle is allocated. Furthermore, a rear side of the upper end portion of each of the grip members or an outer side of the upper end portion of each of the grip members in the vehicle width direction is provided with a concave portion, and a third switch to which a function of increasing or decreasing a characteristic amount of a vehicle behavior control switched (selected) by the second switch among the vehicle behavior controls is allocated is disposed at a bottom of the concave portion.

Note that the vehicle behavior controls include, for example, a traction control over the vehicle and a control over left and right wheels by a differential device of the vehicle. In a case of the traction control, the characteristic amount of the vehicle behavior control is an allowable value of a slip amount of the wheels of the vehicle, and in a case of the control over left and right wheels by the differential device, the characteristic amount of the vehicle behavior control is a differential limiting amount of the differential device.

In this manner, in the present invention, the first switch is provided on the inner side in the vehicle width direction at the upper end portion on each grip member. This arrangement enables the driver to visually confirm the first switch easily and to operate the first switch with the driver's thumb or forefinger. The thumb or forefinger responds to a visually-confirmed object faster than the other fingers. Therefore, the driver can perform upshifting or downshifting with respect to the transmission, which requires the quick operation, by operating the first switch.

Further, the second switch is provided on the front side at the upper end portion on each grip member, and the third switch is disposed at the bottom of the concave portion formed on the rear side at the upper end portion on each grip member or the outer side in the vehicle width direction at the upper end portion on each grip member. In this arrangement, the third switch is positioned lower than the second switch. As a result, when the driver operates the second switch, the driver's fingers are located above the third switch; thus, the driver can operate the second switch suitably. Furthermore, the driver can also operate suitably the third switch positioned closer to the driver than the second switch.

Moreover, the second switch has the function of switching between the vehicle behavior controls, and the third switch has the function of increasing or decreasing the characteristic amount. Thus, the driver can set a desired characteristic amount in regard to a desired vehicle behavior control by operating the second switch and the third switch.

Thus, according to the present invention, the operability of the first to third switches can be improved by disposing the first to third switches on the upper end portion of the grip member.

Here, the grip members are connected to each other so that moving one of the grip members backward causes another one of the grip members to move forward. In this case, the right grip member is moved backward and the left grip member is moved forward, whereby the vehicle turns right or changes a direction to right. On the other hand, the left grip member is moved backward and the right grip member is moved forward, whereby the vehicle turns left or changes a direction to left.

Thus, the motion of the left and right grip members in the front-back direction corresponds to the motion of the driver's arms for operating a commonly-used round steering wheel. As a result, the driver who is accustomed to operation of the commonly-used round steering wheel can smoothly operate the left and right grip members.

When the vehicle behavior control is a traction control of the vehicle, the third switch functions to increase or decrease an allowable value of a slip amount of wheels of the vehicle. On the other hand, when the vehicle behavior control is a control over left and right wheels by a differential device of the vehicle, the third switch functions to increase or decrease a differential limiting amount of the differential device. In either case, the vehicle behavior control (the traction control or the control over the left and right wheels by the differential device) can be switched or the characteristic amount (the allowable value, or the differential limiting amount) for the switched vehicle behavior control can be increased or decreased.

In addition, a side surface portion of the grip member may be provided with a fourth switch for connecting or disconnecting a clutch of the vehicle. The connection and disconnection of the clutch are not included in the functions of the steering members; however, it is important for the vehicle. Therefore, the fourth switch is provided on the side surface portion of the grip member, separately from the first to third switches. This arrangement enables the driver to operate the fourth switch suitably.

When each grip member is a grip part with a columnar shape extending in a vertical direction, the driver in the driver's seat can easily hold the grip part and can also operate the first to third switches in a state of holding the grip part while the vehicle is driving. Thus, the operability of the first to third switches can be improved further.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic structure diagram of a vehicle incorporating a vehicle steering device according to one embodiment of the present invention;

FIG. 2 is a front view illustrating a schematic example of an internal structure of a connection mechanism that connects left and right steering members to a steering shaft;

FIG. 3 is a schematic plan view of the vehicle illustrated in FIG. 1;

FIG. 4 is a front view of a grip part when a vehicle keeps going straight forward; and

FIG. 5 is a schematic side view illustrating a state in which a driver operates an on-off switch.

### DESCRIPTION OF THE PREFERRED EMBODIMENTS

A preferred embodiment of a vehicle steering device according to the present invention will hereinafter be described in detail with reference to the accompanying drawings.

### Structure of the Present Embodiment

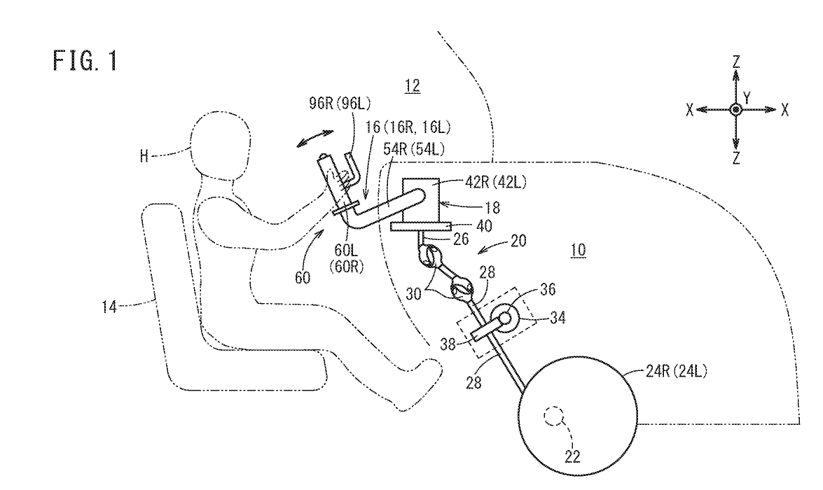

FIG. 1 is a schematic structure diagram of a vehicle 12 incorporating a vehicle steering device 10 according to the present embodiment (hereinafter also referred to as a steering device 10). Note that directions denoted by orthogonal arrows correspond to a vehicle width direction Y, a vehicle length direction X, and a vehicle height direction Z of the vehicle 12.

The steering device 10 basically includes steering members 16 (16L, 16R), which are a pair of operation elements provided on the left and right sides in front of a driver's seat 14, a connection mechanism 18, a steering shaft 20, a rack shaft 22, and front wheels 24L, 24R, which are steered wheels.

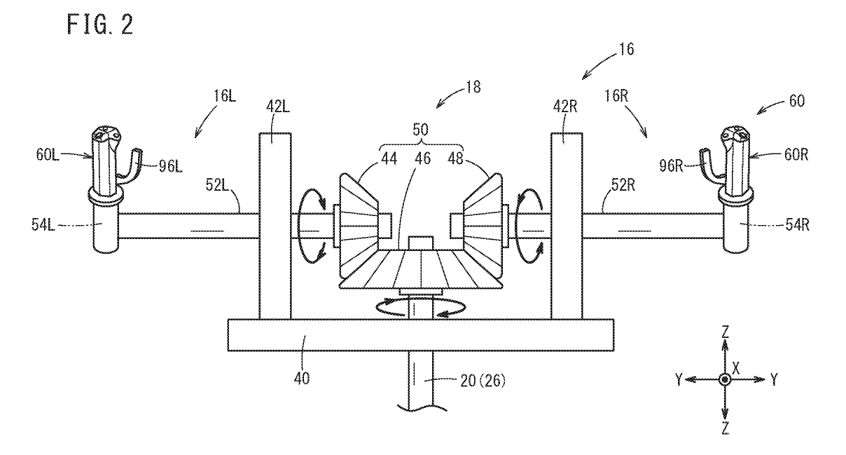

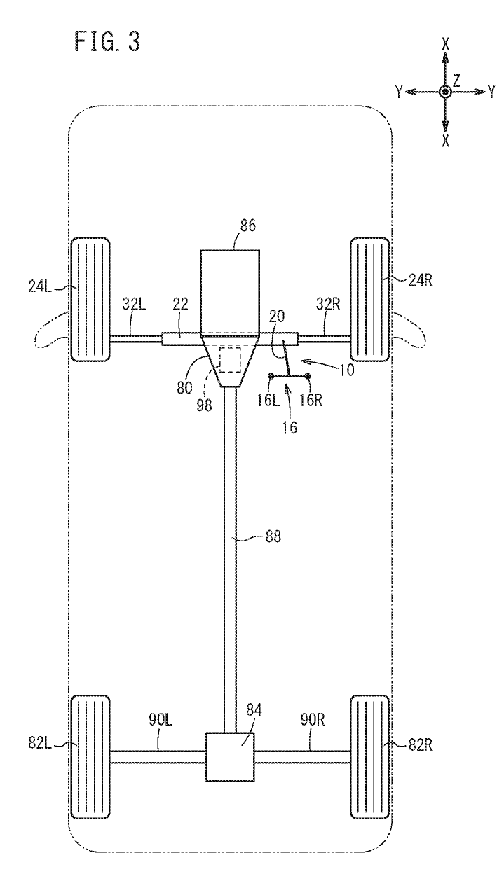

FIG. 2 is a front view illustrating a schematic example of an internal structure of the connection mechanism 18 that connects the left and right steering members 16L, 16R to the steering shaft 20. FIG. 3 is a schematic plan view of the vehicle 12. Note that part of the structure in the vehicle 12 is not shown in order to avoid the complication and help the understanding.

In FIG. 1 to FIG. 3, the steering shaft 20 includes a main shaft 26 connected to the steering members 16 through the connection mechanism 18, and a pinion shaft 28 provided with a pinion gear of a rack and pinion mechanism which is not shown. The main shaft 26 and the pinion shaft 28 are connected to each other with two universal joints 30.

The pinion gear of the rack and pinion mechanism meshes with the rack shaft 22 that can reciprocate in the vehicle width direction Y, and to opposite ends of the rack shaft 22, the left and right front wheels 24L, 24R are connected through tie rods 32L, 32R, respectively.

The steering device 10 includes a motor 34 for an electric power steering device. The motor 34 applies an assistant steering power to the pinion shaft 28. With the assistant steering power, the steering power by the steering members 16 can be reduced.

A worm gear 36 provided on the rotation shaft of the motor 34 meshes with a worm wheel gear 38 provided on the pinion shaft 28.

Although the detailed description is not made because it is well known, the electric power steering device has a reduction gear structured by the worm gear 36 and the worm wheel gear 38, and the reduction gear smoothly converts the rotation driving power of the motor 34, which is controlled based on the steering torque, the steering angle, the vehicle speed, and the like, into the rotation driving power of the pinion shaft 28 in a step-up manner. Note that the torque sensor that detects the steering toque is provided on the steering shaft 20, more specifically on the main shaft 26 or the pinion shaft 28.

As illustrated in FIG. 2, the connection mechanism 18 that connects the steering shaft 20 to the steering members 16 includes a base plate 40 that rotatably supports the steering shaft 20, steering plates 42L, 42R that are provided on the base plate 40 to rotatably support the left and right steering members 16L, 16R, and a gear mechanism 50 including three bevel gears 44, 46, 48.

The gear mechanism 50 also functions as a reverse mechanism that mutually reverses the rotation directions of the left and right steering members 16L, 16R.

The steering members 16 (16L, 16R) include both-side shaft parts 54L, 54R (see FIG. 1 and FIG. 2) and grip parts 60 (60L, 60R) which are grip members each having a columnar shape. When it is assumed that the vehicle 12 keeps going straight forward, the both-side shaft parts 54L, 54R bend and extend in an obliquely downward direction toward the driver's seat 14 from horizontal shaft parts 52L, 52R that extend from the bevel gears 44, 48 toward both sides in the vehicle width direction Y, and each of the grip parts 60 (60L, 60R) bends and extends in an obliquely upward direction from an end of each of the both-side shaft parts 54L, 54R on the driver's seat 14 side.

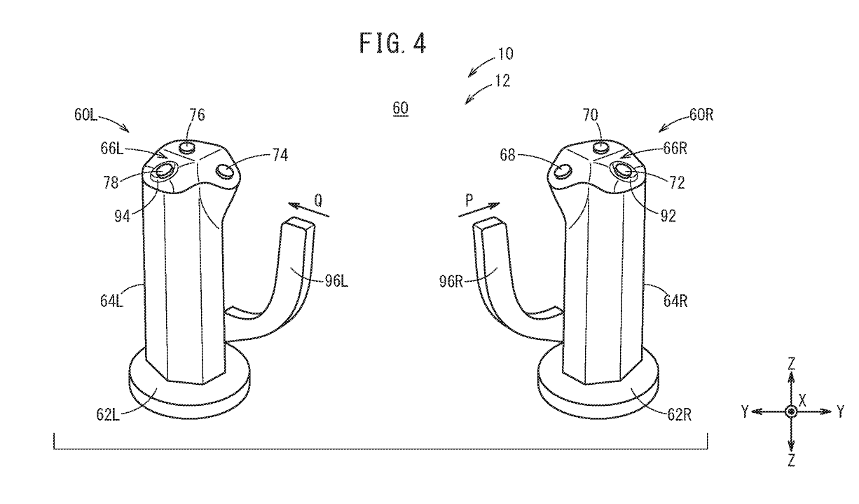

FIG. 4 is a front view enlargedly showing the left grip part 60L and right grip part 60R in FIG. 2 when the vehicle 12 keeps going straight forward, i.e., when the steering members 16 are at a so-called normal position.

In regard to the external shape, the grip parts 60L, 60R have an approximately symmetrical structure when viewed from the driver H in the driver's seat 14.

The grip parts 60L, 60R have a hexagonal columnar shape extending in the vertical direction as a whole. Instead of the hexagonal columnar shape, the grip parts 60L, 60R may have a pentagonal columnar shape, a cylindrical shape, a semi-cylindrical shape whose cross section is semi-circular, or the like.

Lower end portions of the grip parts 60L, 60R are provided with flange parts 62L, 62R, respectively and on the flange parts 62L, 62R, grip main body parts 64L, 64R with a hexagonal columnar shape are provided in a columnar shape (vertically), respectively. Upper end portions of the grip main body parts 64L, 64R are provided as truncated square pyramidal parts 66L, 66R.

Then, in the steering device 10, a plurality of push-button switches are provided on the left and right truncated square pyramidal parts 66L, 66R. That is to say, on the truncated square pyramidal part 66R of the right grip part 60R, a shift-up switch (first switch) 68, an on-off switch (second switch) 70, and a characteristic amount addition switch (third switch) 72 are provided. On the other hand, on the truncated square pyramidal part 66L of the left grip part 60L, a shift-down switch (first switch) 74, an on-off switch (second switch) 76, and a characteristic amount subtraction switch (third switch) 78 are provided.

In this case, the shift-up switch 68 is disposed on the left side surface as viewed from the driver H, that is, on the inner side in the vehicle width direction Y on the truncated square pyramidal part 66R of the right grip part 60R. To the shift-up switch 68, a function of upshifting with respect to a transmission 80 of the vehicle 12 (see FIG. 3) is allocated. Therefore, every time the driver H pushes the shift-up switch 68, the transmission 80 upshifts by one gear.

The shift-down switch 74 is disposed on the right side surface as viewed from the driver H, that is, on the inner side in the vehicle width direction Y on the truncated square pyramidal part 66L of the left grip part 60L. To the shift-down switch 74, a function of downshifting with respect to the transmission 80 is allocated. Therefore, every time the driver H pushes the shift-down switch 74, the transmission 80 downshifts by one gear.

The on-off switch 70 is disposed on the front side as viewed from the driver H on the truncated square pyramidal part 66R of the right grip part 60R. To the on-off switch 70, a function of switching to enabling or disabling of the adjustment for the traction control among a plurality of vehicle behavior controls of the vehicle 12 is allocated. Therefore, every time the driver H pushes the on-off switch 70, the adjustment mode to adjust the allowable value of the slip amount of the wheels of the vehicle 12 (front wheels 24L, 24R and rear wheels 82L, 82R) corresponding to the characteristic amount of the traction control can be turned on or off.

On the other hand, the on-off switch 76 is disposed on the front side as viewed from the driver H on the truncated square pyramidal part 66L of the left grip part 60L. To the on-off switch 76, a function of switching to enabling or disabling of the adjustment for the differential control over the left and right rear wheels 82L, 82R by a differential device 84 of the vehicle 12 among the plurality of vehicle behavior controls is allocated. Thus, every time the driver H pushes the on-off switch 76, the adjustment mode to adjust the differential limiting amount corresponding to the characteristic amount of the differential control can be turned on or off.

Therefore, in this steering device 10, the vehicle behavior controls to be switched by the on-off switches 70, 76 include, for example, the traction control in the vehicle 12 and the control over the left and right rear wheels 82L, 82R by the differential device 84 of the vehicle 12 as described above. Needless to say, in regard to other vehicle behavior controls than these vehicle behavior controls, a function of switching to enabling or disabling of the adjustment for the other vehicle behavior controls can be allocated to the on-off switches 70, 76. As described above, in the case of the traction control, the characteristic amount of the vehicle behavior control is the allowable value of the slip amount of the wheels of the vehicle 12 (front wheels 24L, 24R, and rear wheels 82L, 82R), and in the case of the control over the left and right rear wheels 82L, 82R by the differential device 84, the characteristic amount is the differential limiting amount of the differential device 84.

As one example, FIG. 3 illustrates an FR vehicle as the vehicle 12. The driving power of an engine 86 is transmitted to the differential device 84 through the transmission 80 and a propeller shaft 88. The differential device 84 distributes the transmitted driving power to the left and right, and rotates the left rear wheel 82L through a left output shaft 90L and rotates the right rear wheel 82R through a right output shaft 90R. Since the traction control and the differential control by the differential device 84 are well known, the detailed description thereof is omitted.

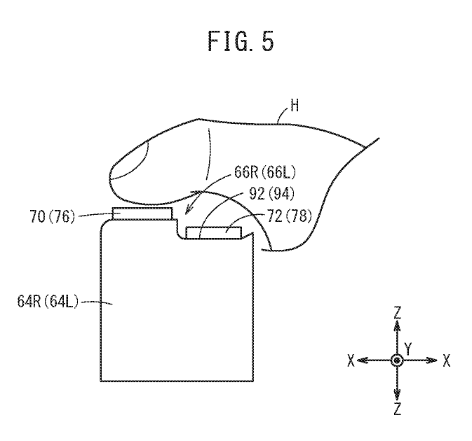

In addition, a concave portion 92 (see FIG. 4 and FIG. 5) is formed on the rear and outer side in the vehicle width direction Y on the truncated square pyramidal part 66R of the right grip part 60R, as viewed from the driver H. At a bottom of this concave portion 92, the characteristic amount addition switch 72 is disposed. The characteristic amount addition switch 72 has a function of, when one of the adjustment modes for the traction control and for the differential control as the vehicle behavior control is turned on by operation of the on-off switches 70, 76, increasing the characteristic amount of the vehicle behavior control in the turned-on adjustment mode (the allowable value of slip amount or differential limiting amount). Therefore, every time the driver H pushes the characteristic amount addition switch 72, the characteristic amount in the turned-on adjustment mode can be increased by an amount corresponding to one operation.

On the other hand, a concave portion 94 is formed on the rear and outer side in the vehicle width direction Y on the truncated square pyramidal part 66L of the left grip part 60L, as viewed from the driver H. At a bottom of this concave portion 94, the characteristic amount subtraction switch 78 is disposed. The characteristic amount subtraction switch 78 has a function of, when one of the adjustment modes for the traction control and for the differential control as the vehicle behavior control is turned on by operation of the on-off switches 70, 76, decreasing the characteristic amount of the vehicle behavior control in the turned-on adjustment mode (the allowable value of slip amount or differential limiting amount). Therefore, every time the driver H pushes the characteristic amount subtraction switch 78, the characteristic amount in the turned-on adjustment mode can be decreased by an amount corresponding to one operation.

Side surface portions of the left and right grip main body parts 64L, 64R are respectively provided with lever switches (fourth switches) 96L, 96R that can be operated in respective directions of an arrow P and an arrow Q and restored to respective home positions, which are shown in the drawing, by spring force. When the lever switches 96L, 96R are restored to the home positions, a clutch 98 of the transmission 80 is in a connected state. Operating one of the lever switches 96L, 96R in the direction of the arrow P or the arrow Q can disconnect the clutch 98.

### Behavior and Operation Method in the Present Embodiment

Next, a behavior and an operation method for the steering device 10 with the structure as above will be described.

The relative positional relation between the steering members 16 and the driver's seat 14 is set in advance such that, when the vehicle keeps going straight forward, the driver H can hold the grip parts 60L, 60R in the driver's left and right hands in a state that the driver bends the left and right elbows.

That is to say, in this steering device 10, the driver H can rotate the steering shaft 20 to steer the front wheels 24L, 24R by holding the grip parts 60L, 60R of the steering members 16L, 16R with the driver's left and right hands respectively, and bending or stretching the driver's left and right arms in the front and back direction as appropriate. That is, the driver H can steer the wheels just by moving the hands holding the grip parts 60L, 60R forward and backward.

Here, specific description is given of the case in which the vehicle turns to right or changes a direction to right. The driver H pulls and tilts the right grip part 60R toward the driver (to the driver's seat 14 side) with the right hand, and at the same time, pushes and tilts the left grip part 60L away from the driver (to the front side of the vehicle 12) with the left hand. This operation causes the right horizontal shaft part 52R of the steering members 16 to rotate in a direction indicated by the arrow of the part 52R in FIG. 2 and at the same time the left horizontal shaft part 52L of the steering members 16 to rotate in a direction indicated by the arrow of the part 52L opposite to the direction indicated by the arrow of the part 52R, as viewed from the driver H. As a result, the steering shaft 20 (pinion shaft 28) is rotated in a direction indicated by the arrow of the shaft 20 (26) (left rotation in a plan view) to cause the rack shaft 22 to move in the right direction. Thus, the front wheels 24L, 24R are tilted to turn right and the motor 34 can assist the steering power.

Next, specific description is given of the case in which the vehicle turns to left or changes a direction to left. The driver H pulls and tilts the left grip part 60L toward the driver with the left hand, and at the same time, pushes and tilts the right grip part 60R away from the driver. This operation causes the left horizontal shaft part 52L of the steering members 16 to rotate in a direction opposite to the direction indicated by the arrow of the part 52L in FIG. 2 and at the same time the right horizontal shaft part 52R to rotate in a direction opposite to the direction indicated by the arrow of the part 52R, as viewed from the driver H. As a result, the steering shaft 20 (pinion shaft 28) is rotated in a direction opposite to the direction indicated by the arrow of the shaft 20 (26) to cause the rack shaft 22 to move in the left direction. Thus, the front wheels 24L, 24R are tilted to turn left and the motor 34 can assist the steering power.

In this manner, the driver H holds the grip parts 60 (60L, 60R) of the steering members 16 (16L, 16R) with the driver's left and right hands, and bends or stretches the driver's left and right arms forward and backward, whereby the left and right front wheels 24L, 24R can be steered to left or right.

Then, while the vehicle 12 is driving, for example, while the vehicle 12 is being turned to left or right, the driver H can operate each switch disposed on the truncated square pyramidal parts 66L, 66R with the driver's fingers in a state that the driver H holds the grip parts 60L, 60R with the driver's left and right hands.

That is, the driver H can shift up a gear in the transmission 80 by pushing the shift-up switch 68 provided on the inner side in the vehicle width direction Y on the truncated square pyramidal part 66R with the driver's thumb or forefinger, and on the other hand, shift down a gear in the transmission 80 by pushing the shift-down switch 74 provided on the inner side in the vehicle width direction Y on the truncated square pyramidal part 66L with the driver's thumb or forefinger.

The driver H turns on the adjustment mode of the traction control by pushing the on-off switch 70 provided on the front side in the vehicle length direction X on the truncated square pyramidal part 66R with the driver's thumb or forefinger and then pushes the characteristic amount addition switch 72 or the characteristic amount subtraction switch 78 with the driver's thumb or forefinger. This operation can increase or decrease the allowable value of the slip amount by the number of times of pushing the switch.

In addition, the driver H turns on the adjustment mode of the differential device 84 by pushing the on-off switch 76 provided on the front side in the vehicle length direction X on the truncated square pyramidal part 66L with the driver's thumb or forefinger and then pushes the characteristic amount addition switch 72 or the characteristic amount subtraction switch 78 with the driver's thumb or forefinger. This operation can increase or decrease the differential limiting amount by the number of times of pushing the switch.

Furthermore, the driver H can disconnect the clutch 98 by operating the lever switch 96L in the direction of the arrow Q with the driver's little finger or operating the lever switch 96R in the direction of the arrow P with the driver's little finger.

### Effect of the Present Embodiment

In the steering device 10 according to the aforementioned embodiment, the shift-up switch 68 and the shift-down switch 74 are provided as the first switches respectively on the inner sides in the vehicle width direction Y on the truncated square pyramidal parts 66L, 66R at upper end portions of the grip parts 60L, 60R. This arrangement enables the driver H to visually confirm the shift-up switch 68 and the shift-down switch 74 easily, and operate the switches with the driver's thumb or forefinger. The thumb or forefinger responds to a visually-confirmed object faster than the other fingers. Therefore, the driver H can perform upshifting or downshifting of the transmission 80, which requires quick operation, by operating the shift-up switch 68 or the shift-down switch 74.

In addition, the on-off switches 70, 76 are disposed as the second switches on the front sides of the truncated square pyramidal parts 66L, 66R. At bottoms of the concave portions 92, 94 formed on the rear and outer sides in the vehicle width direction Y on the truncated square pyramidal parts 66L, 66R, the characteristic amount addition switch 72 and the characteristic amount subtraction switch 78 are disposed as the third switches. With this arrangement, the characteristic amount addition switch 72 and the characteristic amount subtraction switch 78 are positioned lower than the on-off switches 70, 76 as illustrated in FIG. 5. As a result, when the driver H operates the on-off switches 70, 76, the driver's fingers are located above the characteristic amount addition switch 72 and the characteristic amount subtraction switch 78. Therefore, the driver H can suitably operate the on-off switches 70, 76. In addition, the driver H can also suitably operate the characteristic amount addition switch 72 and the characteristic amount subtraction switch 78 which are closer to the driver H than the on-off switches 70, 76.

Furthermore, the function of switching between the plurality of vehicle behavior controls for the vehicle 12 is allocated to the on-off switches 70, 76, and on the other hand, the functions of increasing and decreasing the characteristic amounts in regard to these vehicle behavior controls are allocated respectively to the characteristic amount addition switch 72 and the characteristic amount subtraction switch 78. This enables the driver H to adjust the characteristic amount to a desired characteristic amount for a desired vehicle behavior control by operating the on-off switches 70, 76, the characteristic amount addition switch 72, and the characteristic amount subtraction switch 78.

In this manner, in this steering device 10, on the truncated square pyramidal parts 66L, 66R at the upper end portions of the grip parts 60L, 60R, the shift-up switch 68 and the shift-down switch 74 are disposed on the respective inner sides in the vehicle width direction Y, the on-off switches 70, 76 are disposed on the respective front sides, and the characteristic amount addition switch 72 and the characteristic amount subtraction switch 78 are disposed respectively at the bottoms of the concave portions 92, 94 formed on the rear and outer sides in the vehicle width direction Y. This arrangement can improve the operability of the switches.

Further, in the steering device 10, the grip parts 60L, 60R are connected such that moving one of the grip parts 60L, 60R backward causes the other grip part to move forward. In this case, when the right grip part 60R is moved backward and the left grip part 60L is moved forward, the vehicle 12 turns right or changes a direction to right. On the other hand, when the left grip part 60L is moved backward and the right grip part 60R is moved forward, the vehicle 12 turns left or changes a direction to left.

Thus, the movement of the left grip part 60L and the right grip part 60R in the front-back direction corresponds to the movement of the arms of the driver H for operating a commonly-used round steering wheel. As a result, the driver H who is accustomed to operation of the commonly-used round steering wheel can smoothly operate the left and right grip parts 60L, 60R.

When the vehicle behavior control is the traction control of the vehicle 12, the characteristic amount addition switch 72 and the characteristic amount subtraction switch 78 function as the switches to increase or decrease the allowable value of the slip amount of the front wheels 24L, 24R and the rear wheels 82L, 82R of the vehicle 12. In addition, when the vehicle behavior control is the control over the left and right rear wheels 82L, 82R by the differential device 84, the characteristic amount addition switch 72 and the characteristic amount subtraction switch 78 function as the switches to increase or decrease the differential limiting amount of the differential device 84. In either case, the vehicle behavior control (traction control or control over the left and right rear wheels 82L, 82R by the differential device 84) can be switched and the characteristic amount (allowable value of slip amount, or differential limiting amount) for the switched vehicle behavior control can be increased or decreased.

The lever switches 96L, 96R to connect or disconnect the clutch 98 are provided on side surface portions of the grip parts 60L, 60R, respectively. The connection and disconnection of the clutch 98 are not included in the functions of the steering members 16; however, since the clutch operation is important for the vehicle 12, the lever switches 96L, 96R are provided on the side surface portions of the grip parts 60L, 60R, separately from the above switches. Thus, the driver H can operate the lever switches 96L, 96R suitably.

In addition, since the grip parts 60L, 60R are formed in a columnar shape extending in a vertical direction, the driver H in the driver's seat 14 can easily hold the grip parts 60L, 60R and moreover, even while the vehicle 12 is driving, the driver H can operate the switches while holding the grip parts 60L, 60R. This can further improve the operability of the switches.

In the above description, the characteristic amount addition switch 72 and the characteristic amount subtraction switch 78 are disposed at the bottoms of the concave portions 92, 94 formed on the rear and outer sides in the vehicle width direction Y on the truncated square pyramidal parts 66L, 66R. In the present embodiment, however, each of the concave portions 92, 94 may be formed on one of the rear side and the outer side in the vehicle width direction Y on the corresponding one of the truncated square pyramidal parts 66L, 66R, and the characteristic amount addition switch 72 and the characteristic amount subtraction switch 78 may be disposed respectively at the bottoms of the concave portions 92, 94. In this case, the effect described above can also be obtained easily.

In the above description, the adjustment mode allocated to the on-off switch 70, 76 is switched between ON and OFF every time the on-off switch 70, 76 is pushed. In the present embodiment, however, the on-off switches 70, 76 may be set such that the adjustment object (traction control, differential device 84) of the characteristic amount is switched over every time the on-off switch 70, 76 is pushed once. In this case, the adjustment mode is alternately switched between the adjustment mode for the traction control and the adjustment mode for the differential control every time the driver H pushes the on-off switch 70, 76 once.

In the above description, the shift-up switch 68, the on-off switch 70, and the characteristic amount addition switch 72 are disposed on the right grip part 60R, and the shift-down switch 74, the on-off switch 76, and the characteristic amount subtraction switch 78 are disposed on the left grip part 60L. In the present embodiment, a pair of the left and right switches provided respectively on the left and right grip parts 60L, 60R may be replaced with each other. For example, the characteristic amount addition switch 72 may be disposed at the position of the characteristic amount subtraction switch 78 on the left grip part 60L, and the characteristic amount subtraction switch may be disposed at the position of the characteristic amount addition switch 72 on the right grip part 60R.

Note that the present invention is not limited to the aforementioned embodiment and various structures can be employed based on the description of the present specification.

What is claimed is:

1. A vehicle steering device comprising operation elements which are provided on left and right sides in front of a driver's seat and are moved in a front-back direction of a vehicle by left and right hands of a driver to thereby steer the vehicle, wherein:
the operation elements respectively include grip members to be held by the left and right hands of the driver;
an upper end portion of each of the grip members is provided with a plurality of switches;
an inner side in a vehicle width direction on the upper end portion of each of the grip members is provided with a first switch to which a function of upshifting or downshifting with respect to a transmission of the vehicle is allocated;
a front side of the upper end portion of each of the grip members is provided with a second switch to which a function of switching between a plurality of vehicle behavior controls with respect to the vehicle is allocated;
a rear side of the upper end portion of each of the grip members or an outer side of the upper end portion of each of the grip members in the vehicle width direction is provided with a concave portion; and
a third switch to which a function of increasing or decreasing a characteristic amount of a vehicle behavior control switched by the second switch among the vehicle behavior controls is allocated is disposed at a bottom of the concave portion.

2. The vehicle steering device according to claim 1, wherein:
the grip members are connected to each other so that moving one of the grip members backward causes another one of the grip members to move forward;
a right grip member of the grip members is moved backward and a left grip member of the grip members is moved forward, whereby the vehicle turns right or changes a direction to right; and
the left grip member is moved backward and the right grip member is moved forward, whereby the vehicle turns left or changes a direction to left.

3. The vehicle steering device according to claim 1, wherein:
the vehicle behavior control is a traction control of the vehicle; and
the third switch is configured to increase or decrease an allowable value of a slip amount of wheels of the vehicle as the characteristic amount.

4. The vehicle steering device according to claim 1, wherein:
the vehicle behavior control is a control over left and right wheels by a differential device of the vehicle; and
the third switch is configured to increase or decrease a differential limiting amount of the differential device as the characteristic amount.

5. The vehicle steering device according to claim 1, wherein a side surface portion of each of the grip members is provided with a fourth switch for connecting or disconnecting a clutch of the vehicle.

6. The vehicle steering device according to claim 1, wherein each of the grip members has a columnar shape extending in a vertical direction.
